(19) United States
(12) Patent Application Publication
(10) Pub. No.: US 2005/0107041 A1
(43) Pub. Date: May 19, 2005

(54) Multi-net

(75) Inventor: Yehuda Eder, Rishon Le Tzion (IL)

Correspondence Address: DENNISON, SCHULTZ, DOUGHERTY & MACDONALD, 1727 KING STREET, SUITE 105, ALEXANDRIA, VA, 22314, US

(73) Assignee: Tadiran Communications Ltd.

(21) Appl. No.: 10/712,299

(22) Filed: Nov. 14, 2003

(51) Int. Cl. H04B 1/40

(52) U.S. Cl. 455/77; 455/403

(57) ABSTRACT

A high frequency radio transceiver able to communicate on at least a first high frequency and a second high frequency, wherein said first high frequency is dedicated to a first telecommunication net and said second high frequency is dedicated to a second telecommunication net.

### FIELD OF THE INVENTION

The present invention relates to High Frequency radio communication equipment, and particularly, to an apparatus and method for arranging transceivers into a hierarchical structure of nets.

### BACKGROUND OF THE INVENTION

High frequency (HF) telecommunication occurs over the frequency range of from about 2 MHz to about 30 MHz. By reflection off the ionosphere, messages may be transmitted and received (transceived) between appropriate equipment over very large distances in a reliable manner, even in adverse weather conditions.

To choose appropriate wavelengths for HF telecommunication over particular ranges, under the varying conditions which affect the ionosphere, such as time of day and weather conditions, Automatic Link Establishment, henceforth ALE, is used. This technique combines channel scanning, selective calling and Link Quality Analysis to automatically select the best available wavelength to link suitable transceiving equipment, henceforth transceivers. The requirements for ALE are specified in MIL-STD-188/141B incorporated herein by reference.

Transceivers are arranged into so-called networks to which a number of dedicated high frequency radio frequencies are ascribed. Such networks are of particular interest to the military establishment, as reliable communication is achievable over vast distances, without the limitations of other telecommunication systems requiring hard wired links, line of sight, or limited range. Further details of such networks are provided in MIL-STD188-141B. It will, of course, be appreciated that civilian applications for this type of technology, including diplomacy and industry are also known.

Networked transceivers are capable of contacting other transceivers on the network at the optimal available frequency, or, of contacting all members of the network.

An enhancement to the ALE Standard, developed by Tadiran Communications, the assignee of this application, is a so-called ‘Bi-Directional’ feature. The bidirectional feature enables a transceiver to quickly and efficiently check the quality of a link with other transceivers on a single channel or an all channels of a net.

When contacting a single target transceiver on a single channel (radio frequency), the operator initiates a bidirectional call to the target transceiver on a specific channel. Then the calling transceiver automatically initiates an ALE call to the target transceiver on the selected channel. If a link is not established, the calling transceiver marks the channel as having a 30% quality. If a link is established, the calling transceiver exchanges signals with the target transceiver to test, calculate and generate a quality score for the channel. Once completed, the calling transceiver terminates the link.

The above procedure has also been expanded to enable bidirectional testing of the link between a calling transceiver and a target transceiver on all net channels. Here, having assigned a quality score for the first channel (either 30%, or calculated score), and terminated the link, the calling transceiver repeats the procedure on all the other channels of the net.

Likewise, for a multi-transceiver net, the bidirectional procedure has been expanded to test the quality of the links with all transceivers on all channels.

Networking telecommunication equipment in this manner has many advantages. It will be appreciated however, that by its nature, the network is exclusive to transceivers having appropriate frequencies. Consequently, transceivers not scanning and communicating at those frequencies will be alienated from the network. Such alienated transceivers may themselves be networked on another network. These separate networks, though perhaps geographically overlapping, are unable to interact and the transceivers of the different networks are thus in tele-non-communication or tele-isolation from each other.

There is thus a need to provide a solution to overcome this telecommunication limitation of prior art HF networks as envisaged by MIL-STD188-141B and as currently available, and the present invention is designed to provide transceivers, a novel networking hierarchy and methodology to overcome limitations of the prior art.

### SUMMARY OF THE INVENTION

According to the present invention, there is provided a high frequency radio transceiver able to communicate on at least a first high frequency and a second high frequency, wherein said first high frequency is dedicated to a first telecommunication net and said second high frequency is dedicated to a second telecommunication net.

Preferably, the high frequency radio transceiver is able to scan pre-selected channels of a plurality of nets and having a unique self address in each net.

Typically the plurality of nets includes between 2 and 20 nets.

Typically high frequencies are within a frequency range of from about 2 MHz to about 30 MHz.

In preferred embodiments the high frequency radio transceiver of claim 1 comprises a multi-net task manager for coordinating scanning and sounding on each of said nets.

Preferably, the multi-net task manager coordinates assessment of link quality by a bidirectional function applied to all available channels of all nets.

In a second aspect, there is provided a method of scanning a plurality of nets using the high frequency radio transceiver described above, comprising the steps of:
putting said high frequency radio transceiver into multi-net scanning mode;
scanning channels of first net;
scanning channels of second net;
scanning channels of other nets that said transceiver is compatible with in turn.

Preferably only nets assigned to multi-net operation are scanned.

Preferably, a call will only be answered when its address matches a self address of said transceiver.

Optionally and preferably the scanning operation on each net is performed in accordance with MIL-STD188-141B standard.

In a third aspect there is provided an arrangement of high frequency transceivers comprising a plurality of individual nets, each of said nets containing a plurality of high frequency transceivers enabled to communicate at a plurality of pre-selected high frequency channels dedicated to that net, wherein at least one of said transceivers is able to communicate with transceivers on different nets.

Preferably, the arrangement includes a bidirectional feature for assessing quality of links between said transceivers on said plurality of dedicated pre-selected high frequency channels on said different nets.

By ‘transceiver’, any telecommunication hardware capable of transmitting and receiving telecommunication is intended. Occasionally, the term ‘radio’ is used herein as a noun, to denote a transceiver.

By ‘HF’, high frequency radio communication over the frequency range of from about 2 MHz to about 30 MHz is intended.

By ‘ALE’, Automatic Link Establishment is intended.

By ‘HF telecommunication’ in the context of this patent application, wireless atmospheric telecommunication between transceivers, involving bouncing a High frequency radio wave off the ionosphere is intended.

By ‘net’ a group of stations scanning the same frequencies and having the same net name is intended.

### BRIEF DESCRIPTION OF THE DRAWINGS

The present invention will be further understood and appreciated from the following detailed description taken in conjunction with the drawings in which:

FIG. 1 is a schematic representation of two prior art HF nets, in geo-proximity but tele-non-communication.

FIG. 2 is a flowchart illustrating the procedure of scanning the channels of a net in accordance with ALE-STD188-141B to receive an ALE call for establishing a link between transceivers (prior art).

FIG. 3 is a schematic representation of a multi-net of one embodiment of the present invention comprising two HF nets enabled to intercommunicate.

FIG. 4 is a flowchart illustrating the novel procedure of scanning a multi-net of the present invention.

FIG. 5 is a flowchart illustrating the hierarchical procedure for establishing a link between transceivers on a multi-net in accordance with one embodiment of the present invention.

FIG. 6 is a functional block diagram illustrating multi-net sounding, and the functioning of the multi-net task manager, which is a novel and inventive component that enables the correct functioning of a multi net.

FIG. 7 is a flowchart illustrating a method of applying bidirectional quality assessment to the multi-net of the present invention.

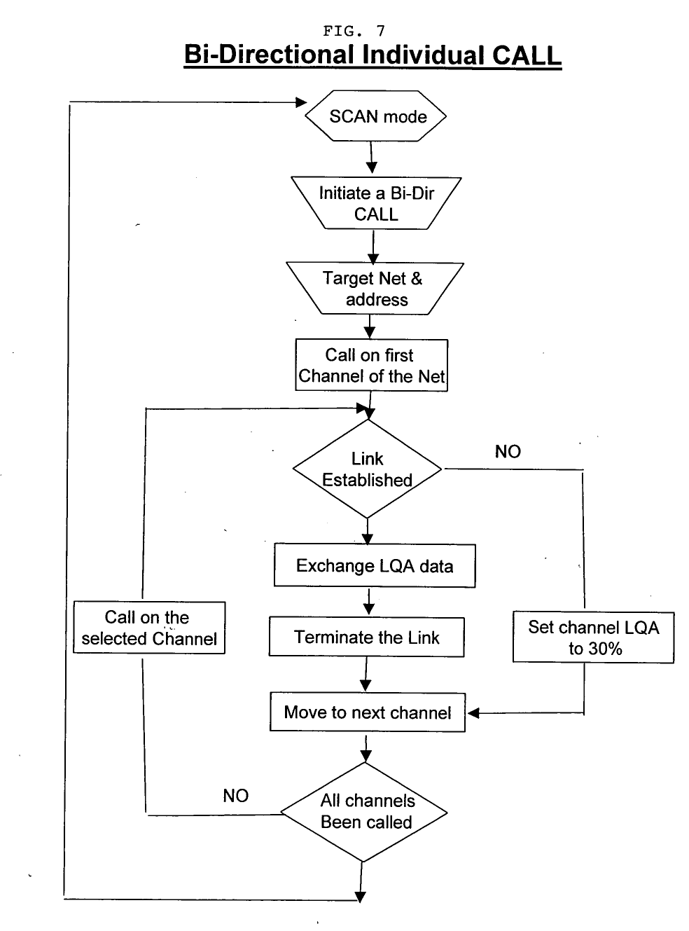

### DETAILED DESCRIPTION OF THE INVENTION

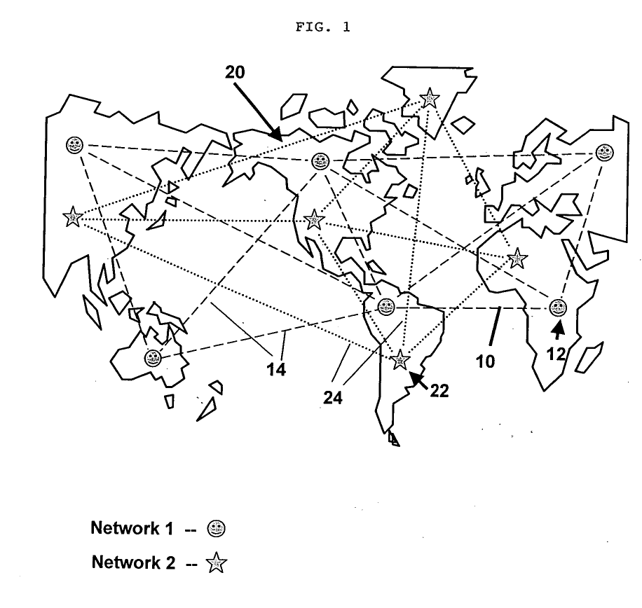

With reference to FIG. 1, there are shown two prior art HF nets, in geo-proximity but in tele-non-communication with each other, i.e. being unable to intercommunicate. The first net 10 comprises a plurality of transceivers 12 indicated by “smileys”, able to establish telecommunication channels therebetween, indicated by dashed lines 14. Similarly, the second net 20 comprises a second plurality of transceivers 22, indicated by star shapes. These too, are able to establish telecommunication channels therebetween, indicated by dotted lines 24. As illustrated, the HF nets 10, 20 may span the world; it being a feature of HF telecommunication that, by bouncing signals off the ionosphere, telecommunication is enabled across vast distances. It will be appreciated though, that individual transceivers need not be separated by vast distances, and HF telecommunication may be used between cities, and is sometimes used between ships and military installations that are geographically quite close together. As illustrated, the two nets 10, 20 overlap in geographical range. This is a common state of affairs, which, where the two nets serve different users, perhaps in very different industries, such as military and civil, or different nationalities, may be an adequate state of affairs, and may even be highly desirable. In practice, operating in certain parts of the world, there are several HF nets that overlap each other partially or fully. To keep the nets independent, preventing interference between different nets, the individual nets are assigned with a limited number of discrete frequencies for telecommunication, and there are international bodies that regulate the distribution of frequencies. To provide security, the ‘handshake’ between transceivers may be coded, and to prevent unauthorized listeners, HF telecommunication may be encrypted.

Not all HF wavelengths are equally appropriate for telecommunication over all distances under all conditions. For telecommunication between two locations, there are a number of preferred wavelengths, and the optimal wavelength actually varies with fluctuations in the ionosphere. Consequently preferred wavelengths vary throughout the seasons and around the clock.

Transceivers that are ALE (Automatic Link Establishment) enabled are known. These are able to send out a handshake signal on a number, say N, of frequencies in turn, thereby allowing the called transceivers to monitor the quality of the link. In this manner the optimal channel, i.e. wavelength is chosen for a particular communication requirement.

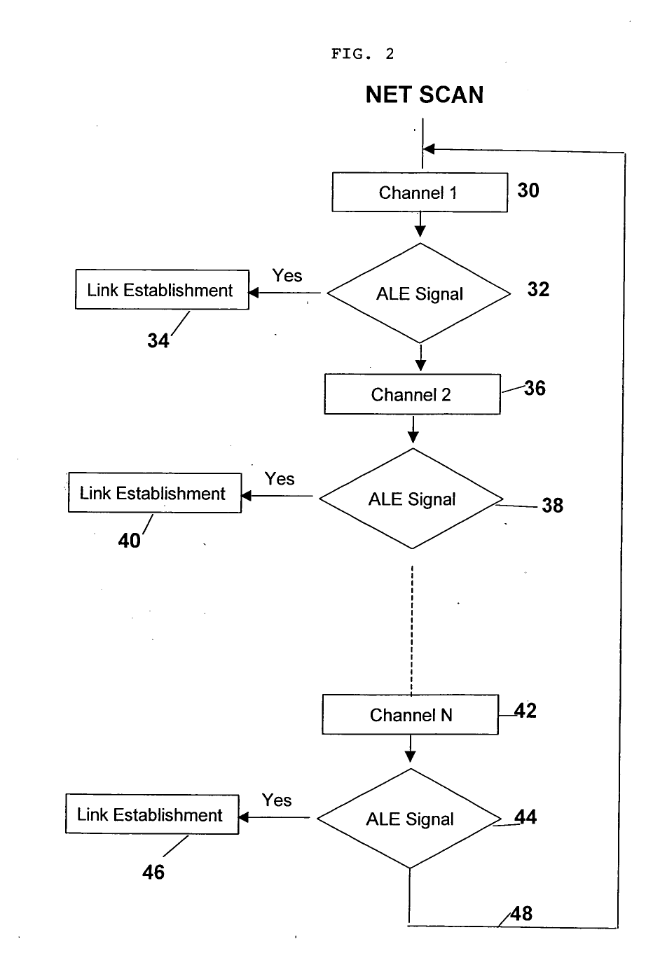

Referring now to FIG. 2, there is shown a flowchart that illustrates the procedure of scanning a net in accordance with ALE-STD188-141B. Receiving transceiver selects (step 30) the first channel (channel 1) and monitors (step 32) for ALE signals on the channel. If a signal is received, a link is established (step 34) with the calling transceiver, and the quality of that link is determined. If not, the transceiver selects (step 36) channel 2. If an ALE signal is received (step 38) and if a link is established (step 40) with the targeted transceiver, the quality of that link is determined. The transceiver continues to scan for signals on each channel in turn until an ALE is determined and a link is established. When the last, or Nth channel is monitored (step 42), if a link is established (step 46) with the calling transceiver, the quality of that link is determined. If not, the receiving transceiver goes back (step 48) and starts scanning the first channel (step 30) again. Such prior art methods are detailed in the MIL-STD188-141B standard and have proven useful for establishing a link on the appropriate channel for optimal communication between selected users on a net. Although the protocols and standards for this scanning procedure have been developed by the military, the technology has proven useful for linking diplomatic missions, oil exploration teams, drilling platforms and the like, and there are a multitude of applications where it has been found to be appropriate.

It will be appreciated however, that there are scenarios where a single, autonomous, functioning, isolated net of transceivers provides a state of affairs that provide a less than ideal telecommunication system.

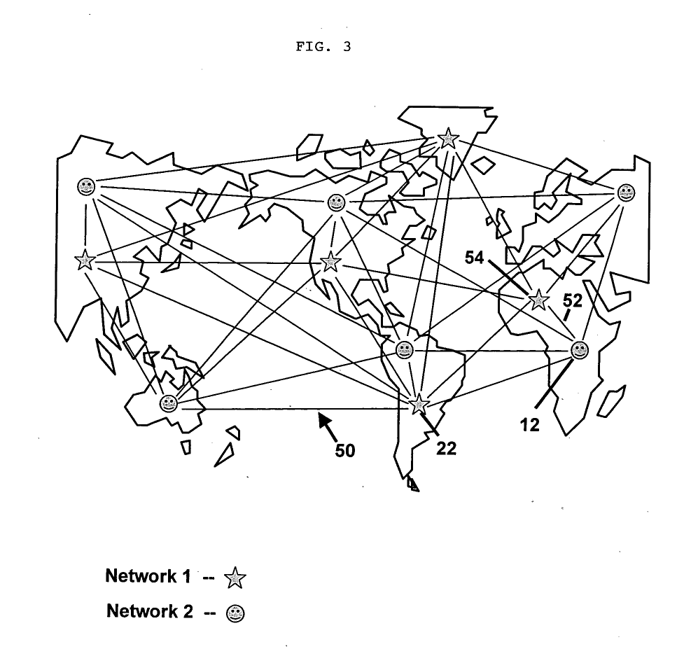

With reference now to FIG. 3, there is shown one embodiment of a multi-net 50, which is a hierarchical telecommunications network of a plurality of the HF nets of the prior art, as illustrated and described hereinabove.

The multi-net 50 allows transceivers 12, 22 on different nets to intercommunicate freely, thus transceiver 54 on network 1 can establish a communication channel 52 with transceiver 12 on network 2.

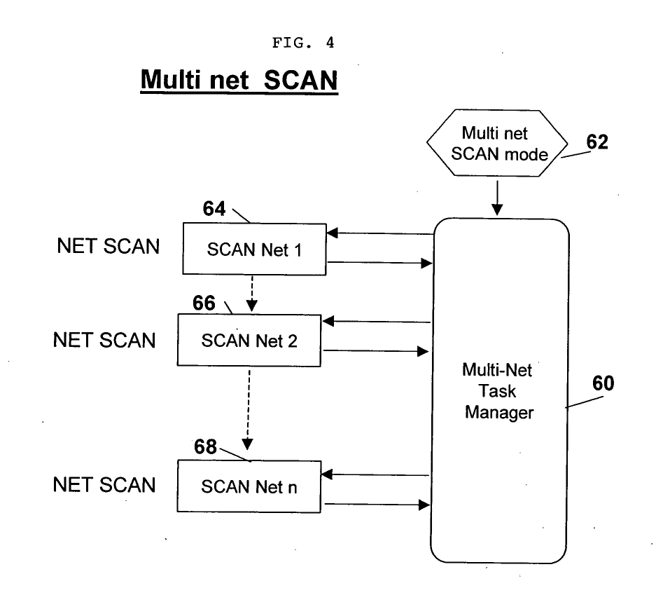

It will be appreciated that not all transceivers within a net 1 of a multi-net 50 need necessarily be able to scan the channels of other nets 2 covered by the multi-net. However, in one aspect, the present invention provides a transceiver capable of scanning the channels of more than one HF telecommunication net. This is facilitated by the provision of a multi-net task manager 60 and, with reference to FIG. 4, there is shown a flowchart that illustrates the novel procedure of scanning a multi-net of the present invention, henceforth known as the ‘multi net scan’. A transceiver capable of performing multi-net scans is put into multi-net scanning mode (step 62), and the multi-net task manager 60 scans, in turn, the individual nets 1, 2, . . . N with which the transceiver capable of scanning the channels of more than one HF telecommunication net is compatible (Step 64, step 66 . . . step 68). Each individual net is scanned by the procedure described above with reference to FIG. 2.

The following points will be noted:
(a) ONLY the nets assigned to the multi-net operation are scanned.
(b) A call will only be answered when the address matches the radio self address
(c) The scan operation on each net is performed in accordance with the directives of the MIL-STD188-141B standard.

In consequence of the above, there is no interference between nets, and stray HF signals from transmitters not on a net within the multi-net are ignored.

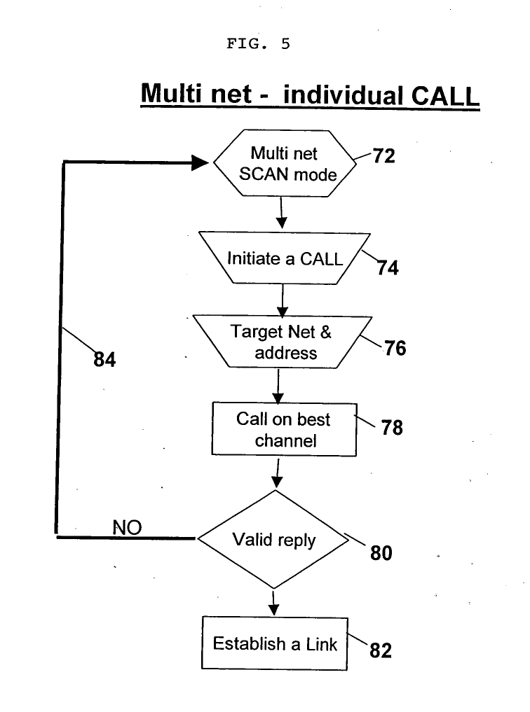

As stated above, a multi-net transceiver may communicate with any prior art transceiver on one of the nets within the multi-net by transceiving on a suitable channel within the appropriate net. It will be appreciated that where a multi-net transceiver attempts to communicate with a second multi-net transceiver, any appropriate channel selected from any common net may be used for the telecommunication. With reference now to FIG. 5, there is shown a flowchart 70 illustrating the hierarchical procedure for establishing a link between transceivers on a multi-net in accordance with one embodiment of the present invention. Firstly, the calling transceiver is put into multi-net mode (Step 72) and a call is initiated (step 74) to a targeted transceiver at a particular geographical location and tuned into a specific net, i.e. targeted net and address 76. The call is sent out on the best channel of the net (step 78), and, if a valid reply is obtained (step 80), a link can be established (step 82). If no valid reply is obtained (step 84), the calling transceiver in multi-net scan mode continues to scan the channels of the second and other nets in turn. In this manner, even under poor conditions, and where the separation of the calling transceiver and receiving transceiver may vary, such as where one or the other is located on a mobile platform such as a ship, airplane or vehicle, a telecommunication link of an appropriate quality may generally be established.

It will be appreciated that although the multi-net default call length is generally in accordance with the defaults of the first net, the user is typically given the option of changing the call length, by defining the number of channels for example. Although a call between two multi-net transceivers may be established on any of the nets, there is no multi-net call per se.

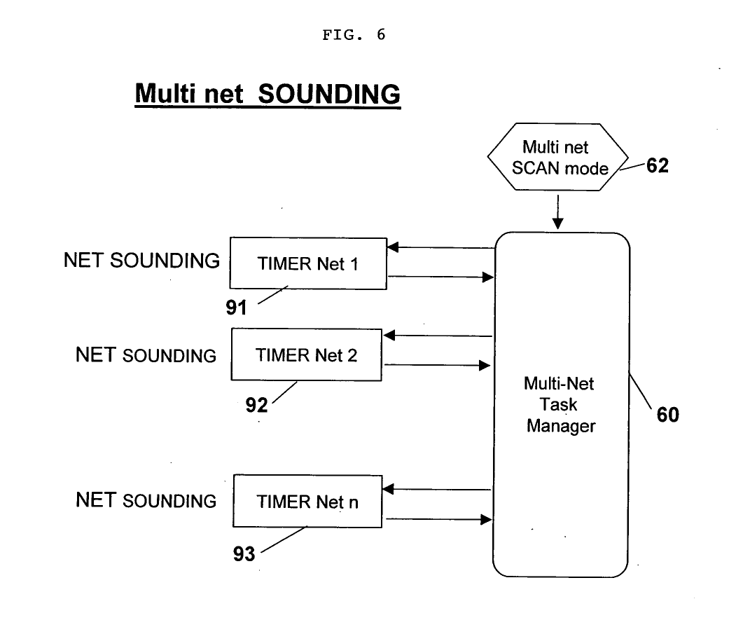

FIG. 6 is a functional block diagram illustrating the requirements for multi-net sounding appropriate to a multi-net. A transceiver equipped for HF multi-net telecommunication, henceforth a multi-net transceiver, preferably includes a multi-net task manager 60, so that when the transceiver is operated in multi-net scan mode 62, a timer associated with net 1 91 sounds net 1 and facilitates establishment of appropriate channels for optimal communication with the various transceivers on net 1. Likewise, there is provided a timer associated with net 2 92 that sounds net 2 and facilitates establishment of appropriate channels for optimal communication with the various transceivers on net 2, and similar timers are provided for all subsequent nets up to and including the timer 93 for the Nth net. Although the individual nets use their own dedicated timer for sounding purposes, the multi-net task manager 60 manages the sounding calls to avoid collisions.

Thus the present invention is directed to enabling intercommunication between stations on different HF nets. Different HF nets are interconnected to provide a “multi-net”, which is essentially a hierarchical net.

A multi-net transceiver of the present invention will be able to scan more than one net, and typically up to about 20 nets, having a unique self address in each net.

An appropriate multi-net transceiver may scan all the channels included in all the nets within the multi-net. Such transceivers are preferably configured such that when an individual incoming call is received from another transceiver, the multi-net transceiver will, once tuned in to the appropriate net and channel, stop scanning the various channels and nets, and instead, answers the call.

When initiating a call to a multi-net radio, the time length of the call sign should be extended according to the number of channels within the multi-net. In this manner, a receiving radio scanning the multi-net will be able to receive the call.

A radio not in multi-net mode, when calling a multi-net radio, should be set to send out a longer than usual call sign, so that the receiving multi-scan transceiver will be tuned into the transmission channel at some time during the call sign.

In general, a transceiver can initiate an individual call to any other transceiver on the same net. The length of the call signal is a function of the number of channels of the net.

The sounding settings of each net within the multi-net may be activated, meaning that the radios (transceivers) of each net should generate sounding calls intermittently in accordance with the time-settings of the net. Typically calling will ensue from ten minutes after a transceiver is switched on at pre-programmed sounding group intervals. The radio software of the multi-net transceiver should manage the calls to avoid collisions.

A listening transceiver in a net will respond to an individual call that includes the net name currently being scanned, and its self address on that net.

As illustrated by the flowchart of FIG. 6, advantageously, the bidirectional feature developed by Tadiran Communication and described above is expanded to allow a quality assessment for the link between all transceivers on all channels of all nets.

Thus there is provided for the first time, a system, method and equipment that enable HF communication between transceiver stations on different nets. From a different perspective, one may understand the present invention as providing a means of integrating several individual nets into a hierarchical net structure, or multi-net.

It will be appreciated that the invention is not limited to what has been described hereinabove merely by way of example. Rather, the invention is limited solely by the claims which follow, in which the word “comprise” and variations thereof, such as “comprising”, “comprised”, and the like, imply that the listed components and steps are included but not generally to the exclusion of other components or steps.

1. A high frequency radio transceiver able to communicate on at least a first high frequency and a second high frequency, wherein said first high frequency is dedicated to a first telecommunication net and said second high frequency is dedicated to a second telecommunication net.

2. A high frequency radio transceiver of claim 1 being able to scan pre-selected channels of a plurality of nets and having a unique self address in each net.

3. A high frequency radio transceiver of claim 2 wherein said plurality of nets includes between 2 and 20 nets.

4. A high frequency radio transceiver of claim 1 wherein said high frequencies are within a frequency range of from about 2 MHz to about 30 MHz.

5. A high frequency radio transceiver of claim 1 comprising a multi-net task manager for coordinating scanning and sounding on each of said nets.

6. A high frequency radio transceiver of claim 5 wherein the multi-net task manager assesses quality of links using a bidirectional function applied to all available channels of all nets.

7. A method of scanning a plurality of nets using the high frequency radio transceiver of claim 6 comprising the steps of:
putting said high frequency radio transceiver into multi-net scanning mode;
scanning channels of first net;
scanning channels of second net;
scanning channels of other nets that said transceiver is compatible with in turn.

8. A method of scanning a plurality of nets using the high frequency radio transceiver of claim 7 wherein only nets assigned to multi-net operation are scanned.

9. A method of scanning a plurality of nets using the high frequency radio transceiver of claim 8 wherein said transceiver listens to an appropriate channel and hears a call signal having an address, and said call signal will only be answered when said address matches a self address of said transceiver.

10. A method of scanning a plurality of nets using the high frequency radio transceiver of claim 7 wherein scanning operation on each net is performed in accordance with directives of MIL-STD188-141B standard.

11. An arrangement of high frequency transceivers comprising a plurality of individual nets, each of said nets containing a plurality of high frequency transceivers enabled to communicate at a plurality of pre-selected high frequency channels dedicated to that net, wherein at least one of said transceivers is able to communicate with transceivers on different nets.

12. The arrangement of claim 11 including a bidirectional feature for assessing quality of links between said transceivers on said plurality of dedicated pre-selected high frequency channels on said different nets.
